(19) United States
(12) Patent Application Publication
(10) Pub. No.: US 2026/0323422 A1
(43) Pub. Date: Oct. 15, 2026

(54) METHOD AND APPARATUS FOR EARLY TA ACQUISITION IN WIRELESS COMMUNICATION SYSTEM

(71) Applicant: SAMSUNG ELECTRONICS CO., LTD., Suwon-si, Gyeonggi-do (KR)

(72) Inventor: Aby Kanneath ABRAHAM, Kerala (IN)

(21) Appl. No.: 19/476,496

(22) PCT Filed: Apr. 12, 2024
(86) PCT No.: PCT/KR2024/004941

§ 371 Date: Oct. 17, 2025

(30) Foreign Application Priority Data
Apr. 17, 2023 (IN) 202341027862
Apr. 1, 2024 (IN) 202341027862

(51) Int. Cl. H04W 36/00; H04W 36/32; H04W 72/232; H04W 74/0838

(52) U.S. Cl. CPC H04W 36/0072; H04W 36/0069; H04W 36/00835; H04W 36/324; H04W 72/232; H04W 74/0838

(57) ABSTRACT

The disclosure relates to a 5th generation (5G) or 6th generation (6G) communication system for supporting a higher data transmission rate. A method performed by terminal in a wireless communication system is provided. The method includes receiving, from a base station, a radio resource control (RRC) message including configuration information associated with an early timing advance (TA) acquisition; receiving, from the base station, a physical downlink control channel (PDCCH) order related to triggering a random access associated with the early TA acquisition on a lower layer triggered mobility (LTM) candidate cell; and performing the random access associated with the early TA acquisition triggered by the PDCCH order, based on the configuration information.

### TECHNICAL FIELD

The present disclosure relates to wireless communication systems, and more particularly, the disclosure relates to a method and an apparatus for early timing advance (TA) acquisition in a wireless communication system.

### BACKGROUND ART

5th generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra eliable low latency communications (URLLC), and massive machine-type communications (mMTC), there has been ongoing standardization regarding beamforming and massive multiple-input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio user equipment (NR UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices, which have been exponentially increasing, will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the present disclosure. No determination has been made, and no assertion is made, as to whether any of the above might be applicable as prior art with regard to the disclosure.

### DISCLOSURE OF INVENTION

### Solution to Problem

The disclosure provides a method and an apparatus for early TA acquisition in a wireless communication system.

### BRIEF DESCRIPTION OF DRAWINGS

The present disclosure is illustrated in the accompanying drawings, throughout which like reference letters indicate corresponding parts in the various figures. The embodiments herein will be better understood from the following description with reference to the drawings, in which:

FIG. 1 illustrates a wireless network for performing random access for early timing advance, according to the embodiments as disclosed herein;

FIG. 2 illustrates another wireless network for performing random access for early timing advance, according to the embodiments as disclosed herein;

FIG. 3 shows various hardware components of a UE, according to the embodiments as disclosed herein;

FIG. 4 is a flow chart illustrating a method, implemented by the UE, for performing random access for early timing advance, according to the embodiments as disclosed herein;

FIG. 5 is a flow chart illustrating operations performed for random access channel (RACH) for early TA, according to an embodiment disclosed herein;

FIG. 6 is a flow chart illustrating a method, implemented by the wireless network, for performing random access for early timing advance, according to the embodiments as disclosed herein;

FIG. 7 is sequence diagram illustrating operations performed Self-Organizing Networks (SON) for RACH for early TA, according to an embodiment disclosed herein;

FIG. 8 is a diagram illustrating a UE according to an embodiment of the present disclosure; and

FIG. 9 is a diagram illustrating a base station according to an embodiment of the present disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

Throughout the present disclosure, the expression “at least one of a, b or c” indicates only a, only b, only c, both a and b, both a and c, both b and c, all of a, b, and c, or variations thereof. Throughout the specification, a layer (or a layer apparatus) may also be referred to as an entity. Hereinafter, operation principles of the disclosure will be described in detail with reference to accompanying drawings. In the following descriptions, well-known functions or configurations are not described in detail because they would obscure the disclosure with unnecessary details. The terms used in the specification are defined in consideration of functions used in the disclosure, and can be changed according to the intent or commonly used methods of users or operators. Accordingly, definitions of the terms are understood based on the entire descriptions of the present specification.

For the same reasons, in the drawings, some elements may be exaggerated, omitted, or roughly illustrated. Also, a size of each element does not exactly correspond to an actual size of each element. In each drawing, elements that are the same or are in corre-spondence are rendered the same reference numeral.

Advantages and features of the present disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein; rather, these embodiments of the disclosure are provided so that this disclosure will be thorough and complete, and will fully convey the concept of the disclosure to one of ordinary skill in the art. Therefore, the scope of the present disclosure is defined by the appended claims. Throughout the specification, like reference numerals refer to like elements. It will be understood that blocks in flowcharts or combinations of the flowcharts may be performed by computer program instructions. Because these computer program instructions may be loaded into a processor of a general-purpose computer, a special-purpose computer, or another programmable data processing apparatus, the instructions, which are performed by a processor of a computer or another programmable data processing apparatus, create units for performing functions described in the flowchart block(s).

The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufactured items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It is also noted that, in some alternative implementations, functions mentioned in blocks may occur out of order. For example, two consecutive blocks may also be executed simultaneously or in reverse order depending on functions corresponding thereto.

As used herein, the term “unit” denotes a software element or a hardware element such as a field-programmable gate array (FPGA) or an application-specific integrated circuit (ASIC), and performs a certain function. However, the term “unit” is not limited to software or hardware. The “unit” may be formed so as to be in an addressable storage medium, or may be formed so as to operate one or more processors. Thus, for example, the term “unit” may include elements (e.g., software elements, object-oriented software elements, class elements, and task elements), processes, functions, attributes, procedures, subroutines, segments of program code, drivers, firmware, micro-codes, circuits, data, a database, data structures, tables, arrays, or variables.

Functions provided by the elements and “units” may be combined into the smaller number of elements and “units,” or may be divided into additional elements and “units.” Furthermore, the elements and “units” may be embodied to reproduce one or more central processing units (CPUs) in a device or security multimedia card. Also, in an embodiment of the present disclosure, the “unit” may include at least one processor. In the following descriptions of the disclosure, well-known functions or configurations are not described in detail because they would obscure the disclosure with unnecessary details.

Hereinafter, for convenience of explanation, the present disclosure uses terms and names defined in the 3rd generation partnership project long term evolution (3GPP LTE) standards. However, the disclosure is not limited to the terms and names, and may also be applied to systems following other standards.

In the present disclosure, an evolved node B (eNB) may be interchangeably used with a next-generation node B (gNB) for convenience of explanation. That is, a base station (BS) described by an eNB may represent a gNB. In the following descriptions, the term “base station” refers to an entity for allocating resources to a user equipment (UE) and may be used interchangeably with at least one of a gNode B, an eNode B, a node B, a base station (BS), a radio access unit, a base station controller (BSC), or a node over a network. The term “terminal” may be used interchangeably with a UE, a mobile station (MS), a cellular phone, a smartphone, a computer, or a multimedia system capable of performing communication functions. However, the disclosure is not limited to the aforementioned examples. In particular, the disclosure is applicable to 3GPP new radio (NR) (or 5th generation (5G)) mobile communication standards. In the following description, the term eNB may be interchangeably used with the term gNB for convenience of explanation. That is, a base station explained as an eNB may also indicate a gNB. The term UE may also indicate a mobile phone, NB-IoT devices, sensors, and other wireless communication devices.

In a 5G wireless communication system, a random access (RA) is supported. The RA is used to achieve uplink (UL) time synchronization. The RA is used during initial access, handover, radio resource control (RRC) connection re-establishment procedure, scheduling request transmission, secondary cell group (SCG) addition/modification, beam failure recovery and data or control information transmission in the UL by non-synchronized UE in a RRC CONNECTED state. Several types of random access procedure is supported. The Random Access procedure is described in section 5.1 of TS 38.321 and is initiated by a PDCCH order, by a Medium Access Control (MAC) entity itself, or by the RRC. There is only one Random Access procedure ongoing at any point in time in a MAC entity.

Thus, it is desired to address the above mentioned disadvantages or other shortcomings or at least provide a useful alternative.

The principle object of the embodiments herein is to provide a method and system for self-optimization (including optimizations for minimization of drive tests) of random access in wireless networks like 5G NR network.

Yet another object of the embodiments herein is to provide a method and system to perform random access procedure by sending a UE random access information to a network entity in the 5G NR network.

Yet another object of the embodiments herein is to provide the methods and systems for sending random access channel (RACH) information to the network entity by a User Equipment (UE) in the 5G NR network.

Yet another object of the embodiments herein is to provide the method for performing random access for a Lower-layer Triggered Mobility (LTM) for early TA and the optimization of random access performed for the LTM.

Yet another object of the embodiments herein is to provide a method by which a UE is configured by a network entity for resources for early TA synchronization.

Yet another object of the embodiments herein is to provide a method of signaling between a gNB centralized unit (CU) and a gNB distributed unit (DU) for configuration for early TA synchronization.

Yet another object of the embodiments herein is to provide a method for performing random access optimisations for the LTM early synchronization.

Accordingly, embodiments herein disclose a method for optimizing random access in a wireless network. The method includes informing, by a UE, capability information to a network entity in the wireless network. The capability information indicates whether the UE is capable for performing random access for early Timing Advance (TA) on at least one Lower-layer Triggered Mobility (LTM) candidate cell. Further, the method includes receiving, by the UE, a configuration to perform random access towards the at least one LTM candidate cell for receiving the early TA. Further, the method includes receiving, by the UE, a Physical Downlink Control Channel (PDCCH) order from a serving cell to perform the random access towards the at least one LTM candidate cell for receiving the early timing advance. Further, the method includes performing, by the UE, random access towards the at least one LTM candidate cell for receiving the early timing advance. Further, the method includes logging and reporting, by the UE, random access related information about the performed random access.

In an embodiment, the capability information is informed using a single bit of per-UE capability in a UE capability information message.

In an embodiment, the configuration to perform the random access includes contention free random access (CFRA) resources, where the CFRA resources are separate from the CFRA resources provided for performing a cell switch.

In an embodiment, the random access related information for the early timing advance comprises at least one of: a candidate cell index or a cell identifier of the at least one LTM candidate cell for which random access is performed for the early TA measurement, and a cell identifier of a source cell and an information in which the random access is performed for receiving the early timing advance.

In an embodiment, the information in which the random access is performed for receiving the early timing advance is provided through a raPurpose field in a RA-Report.

In an embodiment, the information in which the random access is performed for receiving the early timing advance is included in a SCG-related RA report.

In an embodiment, the cell identifier is combination of at least one of: a physical cell identifier and a NR-ARFCN (New Radio Absolute Radio Frequency Channel Number), and a global cell identifier.

In an embodiment, the UE reports the random access related information for receiving the early timing advance in at least one of: a random access report, a radio link failure report, a connection establishment failure report, a successful handover report and a successful PSCellAddition or Change report.

Accordingly, embodiments herein disclose a method for performing random access for early timing advance in a wireless network. The method includes informing, by a gNB centralized unit (CU), a gNB distributed unit (DU) whether a gNB DU configures a UE for performing early TA for a candidate cell. Further, the method includes configuring, by the gNB DU, the configuration for random access for early timing advance in the wireless network in response to informing.

Accordingly, embodiments herein disclose a UE for performing and optimizing random access in a wireless network. The UE includes a random access controller communicatively coupled to a memory and a processor. The random access controller is configured to inform capability information to a network entity in the wireless network, wherein the capability information indicates whether the UE is capable for performing random access for early TA on at least one LTM candidate cell. Further, the random access controller is configured to receive a configuration to perform random access towards the at least one LTM candidate cell for receiving the early TA. Further, the random access controller is configured to receive a PDCCH order from a serving cell to perform the random access towards the at least one LTM candidate cell for receiving the early timing advance. Further, the random access controller is configured to perform random access towards the at least one LTM candidate cell for receiving the early timing advance. Further, the random access controller is configured to log and report random access related information about the performed random access.

Accordingly, embodiments herein disclose a wireless network for performing random access for early timing advance. The wireless network includes a gNB CU informing a gNB DU whether a gNB DU configures a UE for performing early TA for a candidate cell. The gNB DU configures a configuration for random access for early timing advance in the wireless network in response to informing.

These and other aspects of the embodiments herein is better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semi-conductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, embodiments herein disclose a methods and systems for self-optimization (including optimizations for minimization of drive tests) of random access in a wireless network like 5G NR network. The methods can be used to send random access information to a network entity by the UE in the 5G NR network.

In an embodiment, a gNB CU receives new information and optimizes random access related parameters itself. Further, the gNB CU transfers the information to a gNB DU and Operations, Administration, and Maintenance (OAM) modules. In an embodiment, the UE logs and reports the information to a network entity (e.g., gNB or the like). In an embodiment, the reception of the report is performed by the gNB CU through a RRC message UE Information Response (such as NR UEInformation-Response). In an embodiment, performing the random access for early Timing Advance (TA) includes transmitting the random access preamble. In an embodiment, performing the random access for early TA includes one or more of transmitting the random access preamble, waiting for the response including timing advance, receiving the response and processing the same.

In an embodiment, the UE which has performed random access for Timing Advance (TA) measurement for LTM candidate cells, and has transmitted the maximum number of RA preambles (for e.g. PREAMBLE_TRANSMISSION_COUNTER becomes equal to preambleTransMax+1, whereas PREAMBLE_TRANSMISSION_COUNTER and preambleTransMax are as defined in TS 38.321/TS 38.331), but has not succeeded, considers the random access procedure (as described in TS 38.321 MAC specification v17.4.0) as unsuccessfully completed. In an embodiment, the transmission of random access preambles for early TA is considered as not succeeded, if the UE has not successfully received a random access response or a MAC CE which provides the timing advance or any other relevant response. In an embodiment, when the UE MAC layer has transmitted maximum number of random access preambles for early TA, it skips reporting the Random Access Problem to upper layers and UE RRC doesn't declare a RLF on the cell group (MCG/SCG) where the maximum number of RA preambles for early TA is send.

Contention Based Random Access (CBRA): In this type of random access, the UE first transmits Random Access preamble (also referred as Msg1) and then waits for Random access response (RAR) in a RAR window. The RAR is also referred as Msg2. Next generation node B (gNB) transmits the RAR on a physical downlink shared channel (PDSCH). A PDCCH (physical downlink control channel) scheduling the PDSCH carrying RAR is addressed to RA-radio network temporary identifier (RA-RNTI). The RA-RNTI identifies the time-frequency resource (also referred as physical RA channel (PRACH) occasion or PRACH transmission (TX) occasion or RA channel (RACH) occasion) in which RA preamble was detected by the gNB. If the RAR corresponding to its RA preamble transmission is received, the UE transmits message 3 (i.e., Msg3) in a UL grant received in RAR. The Msg3 includes message such as RRC connection request, RRC connection re-establishment request, RRC handover confirm, scheduling request, SI request etc. It may include the UE identity (i.e. cell-radio network temporary identifier (C-RNTI) or system architecture evolution (SAE)-temporary mobile subscriber identity (S-TMSI) or a random number). After transmitting the Msg3, the UE starts a contention resolution timer. While the contention resolution timer is running, if the UE receives a physical downlink control channel (PDCCH) addressed to the C-RNTI included in Msg3, contention resolution is considered successful, contention resolution timer is stopped and RA procedure is completed. While the contention resolution timer is running, if the UE receives contention resolution MAC control element (CE) including the UE's contention resolution identity (first X bits of common control channel (CCCH) service data unit (SDU) transmitted in Msg3), contention resolution is considered successful, contention resolution timer is stopped and RA procedure is completed. If the contention resolution timer expires and the UE has not yet transmitted the RA preamble for a configurable number of times, the UE goes back to first step i.e. select random access resource (preamble/RACH occasion) and transmits the RA preamble. A backoff may be applied before going back to first step.

Contention Free Random Access (CFRA): A CFRA procedure is used for scenarios such as the handover where low latency is required, timing advance establishment for secondary cell (Scell), etc. A 5G node B (e.g., 5G gNB) assigns to the UE dedicated Random access preamble. The UE transmits the dedicated RA preamble. The gNB transmits the RAR on the PDSCH addressed to RA-RNTI. RAR conveys RA preamble identifier and timing alignment information. RAR may also include UL grant. RAR is transmitted in RAR window similar to contention based RA (CBRA) procedure. The CFRA is considered successfully completed after receiving the RAR including RA preamble identifier (RAPID) of RA preamble transmitted by the UE. In case RA is initiated for beam failure recovery, the CFRA is considered successfully completed if PDCCH addressed to C-RNTI is received in search space for beam failure recovery. If the RAR window expires and RA is not successfully completed and UE has not yet transmitted the RA preamble for a configurable (configured by gNB in RACH configuration) number of times, the UE retransmits the RA preamble.

Contention Based Random Access (2 Step CBRA): In the first step, the UE transmits random access preamble on the PRACH and a payload (i.e. MAC PDU) on PUSCH. The random access preamble and payload transmission is also referred as MsgA. In the second step, after MsgA transmission, the UE monitors for a response from the network (i.e. gNB) within a configured window. The response is also referred as/MsgB. If CCCH SDU was transmitted in MsgA payload, the UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, UE transmits Msg3 and performs contention resolution using Msg4 as in CBRA procedure. If contention resolution is successful, random access procedure is considered successfully completed. If contention resolution fails upon fallback (i.e. upon transmitting Msg3), UE retransmits MsgA. If configured window in which UE monitor network response after transmitting MsgA expires and UE has not received MsgB including contention resolution information or fallback information as explained above, UE retransmits MsgA. If the random access procedure is not successfully completed even after transmitting the msgA configurable number of times, UE fallbacks to 4 step RACH procedure i.e. UE only transmits the PRACH preamble.

Contention Free Random Access (2 Step CFRA): The gNB assigns to UE dedicated Random access preamble(s) and PUSCH resource(s) for MsgA transmission. RACH Occasions RO(s) to be used for preamble transmission may also be indicated. In the first step, the UE transmits random access preamble on PRACH and a payload on PUSCH using the contention free random access resources (i.e. dedicated preamble/PUSCH resource/RO). In the second step, after MsgA transmission, the UE monitors for a response from the network (i.e. gNB) within a configured window. If UE receives PDCCH addressed to C-RNTI, random access procedure is considered successfully completed. If the UE receives fallback information corresponding to its transmitted preamble, random access procedure is considered successfully completed.

| | |
|---|---|
| MsgAConfigCommon | The field is optionally present, Need |
| | S, if FeatureCombinationPreambles |
| | is included in RACH- |
| | ConfigCommonTwoStepRA. |
| | Otherwise, it is absent. If the field is |
| | absent in |
| | FeatureCombinationPreambles |
| | included in RACH- |
| | ConfigCommonTwoStepRA, the UE |
| | applies MsgA-PUSCH-Config |
| | included in the corresponding MsgA- |
| | ConfigCommon. |

Self Optimisation in NR: A 5G NR (new radio) radio access network also known as NG-RAN (Next Generation Radio Network) comprises of a number of NR base stations knows as gNBs. The gNBs can be connected to each other through Xn interface, and will be connected to various core network elements like AMF (Access and Mobility Management Function), UPF (User Plane Function) etc. Further gNBs can be divided into two physical entities named CU (Centralized Unit) and DU (Distributed Unit). The CU provides support for the higher layers of the protocol stack such as SDAP (Session Data Application Protocol), PDCP (Packet Data Convergence Protocol) and RRC (Radio Resource Control) while DU provides support for the lower layers of the protocol stack such as RLC (Radio Link Control), MAC (Medium Access Control) and Physical layer. Each gNB can have multiple cells serving many UEs (User Equipment). There are a large number of algorithms and configuration parameters used in NG-RAN. Especially, it is a very difficult task to identify the most optimal radio parameters and operators used to resort to manual techniques like drive tests to identify the parameters. However, such manual parameter tuning is a costly operation since it depends on a lot of factors like the number of users, number of neighbors, maximum throughput in the cell, average throughput in the cell etc. Further, whenever a neighbor gNB is installed or a new service is introduced, many of these manual operations need to be repeated. To resolve this problem, 3gpp has introduced Self-Organizing Networks (SON) techniques in the wireless technologies like NR. SON was first introduced in 3gpp release 9, in LTE. SON solutions can be divided into three categories: Self-Configuration, Self-Optimization and Self-Healing. The SON architecture can be a centralized, distributed or a hybrid solution.

Self-optimization of RACH aims to minimize the number of attempts on the RACH. UE can report the detailed information about RACH in the RACH Report to the network and the network will optimize various parameters associated with RACH using the information. A List of information that the UE could report in RACH is given as below based on NR TS 38.331

RA-ReportList-r16 ::= SEQUENCE (SIZE (1..maxRAReport-r16)) OF RA-Report-r16

| | |
|---|---|
| RA-Report-r16 ::= | SEQUENCE { |
| cellId-r16 | CHOICE { |
| cellGlobalId-r16 | CGI-Info-Logging-r16, |
| pci-arfcn-r16 | SEQUENCE { |
| physCellId-r16 | PhysCellId, |
| carrierFreq-r16 | ARFCN-ValueNR |

```
    }
  },
```

| | |
|---|---|
| ra-InformationCommon-r16 | RA-InformationCommon-r16 |

OPTIONAL,

| | |
|---|---|
| raPurpose-r16 | ENUMERATED {accessRelated, beamFailureRecovery, |

reconfigurationWithSync, ulUnSynchronized,

schedulingRequestFailure,

noPUCCHResourceAvailable, requestForOtherSI,

spare9, spare8, spare7, spare6, spare5, spare4, spare3,

spare2, spare 1},
...
}

| | |
|---|---|
| RA-InformationCommon-r16 ::= | SEQUENCE { |
| absoluteFrequencyPointA-r16 | ARFCN-ValueNR, |
| locationAndBandwidth-r16 | INTEGER (0..37949), |
| subcarrierSpacing-r16 | SubcarrierSpacing, |

| | |
|---|---|
| msg1-FrequencyStart-r16 | INTEGER (0..maxNrofPhysicalResourceBlocks-1) |

OPTIONAL,

| | |
|---|---|
| msg1-FrequencyStartCFRA-r16 | INTEGER (0..maxNrofPhysicalResourceBlocks-1) |

OPTIONAL,

| | |
|---|---|
| msg1-SubcarrierSpacing-r16 | SubcarrierSpacing |

OPTIONAL,

| | |
|---|---|
| msg1-SubcarrierSpacingCFRA-r16 | SubcarrierSpacing |

OPTIONAL,

| | | |
|---|---|---|
| msg1-FDM-r16 | ENUMERATED {one, two, four, eight} | OPTIONAL, |

| | |
|---|---|
| msg1-FDMCFRA-r16 | ENUMERATED {one, two, four, eight} |

OPTIONAL,

| | |
|---|---|
| perRAInfoList-r16 | PerRAInfoList-r16, |

```
  ...,
  [[
```

| | |
|---|---|
| perRAInfoListExt-v1660 | PerRAInfoListExt-v1660 |

```
OPTIONAL
    ]],
  [[
```

| | |
|---|---|
| msgA-FrequencyStart-r17 | INTEGER (0..maxNrofPhysicalResourceBlocks-1) |

OPTIONAL,

| | |
|---|---|
| msgA-FrequencyStartCFRA-r17 | INTEGER (0..maxNrofPhysicalResourceBlocks-1) |

OPTIONAL,

| | |
|---|---|
| msgA-SubcarrierSpacing-r17 | SubcarrierSpacing |

OPTIONAL,

| | |
|---|---|
| msgA-SubcarrierSpacingCFRA-r17 | SubcarrierSpacing |

OPTIONAL,

| | |
|---|---|
| msgA-FDM-r17 | ENUMERATED {one, two, four, eight} |

OPTIONAL,

| | |
|---|---|
| msgA-FDMCFRA-r17 | ENUMERATED {one, two, four, eight} OPTIONAL, |

| | |
|---|---|
| measuredDL-RSRP-r17 | RSRP-Range |

OPTIONAL,

| | |
|---|---|
| msgA-TransMax-r17 | ENUMERATED {n1, n2, n4, n6, n8, n10, n20, n50, n100, n200} |

OPTIONAL

| | | |
|---|---|---|
| msgA-MCS-r17 | INTEGER (0..15) | OPTIONAL, |

| | |
|---|---|
| nrofPRBs-PerMsgA-PO-r17 | INTEGER (1..32) |

OPTIONAL,

| | |
|---|---|
| msgA-PUSCH-TimeDomainAllocation-r17 | INTEGER (1..maxNrofUL-Allocations) |

OPTIONAL,

| | |
|---|---|
| frequencyStartMsgA-PUSCH-r17 | INTEGER (0..maxNrofPhysicalResourceBlocks-1) |

OPTIONAL,

| | |
|---|---|
| nrofMsgA-PO-FDM-r17 | ENUMERATED {one, two, four, eight} |

OPTIONAL,

| | | |
|---|---|---|
| dlPathlossRSRP-r17 | RSRP-Range | OPTIONAL, |

| | |
|---|---|
| intendedSIBs-r17 | SEQUENCE (SIZE (1..maxSIB)) OF SIB-Type-r17 |

OPTIONAL,

| | |
|---|---|
| ssbsForSI-Acquisition-r17 | SEQUENCE (SIZE (1..maxNrofSSBs-r16)) OF SSB-Index |

OPTIONAL,

| | |
|---|---|
| msgA-PUSCH-PayloadSize-r17 | BIT STRING (SIZE (3)) |

OPTIONAL,

| | |
|---|---|
| onDemandSISuccess-r17 | BOOLEAN |

OPTIONAL
]]
}
PerRAInfoList-r16 ::= SEQUENCE (SIZE (1..200)) OF PerRAInfo-r16
PerRAInfoListExt-v1660 ::= SEQUENCE (SIZE (1..200)) OF PerRACSI-RSInfoExt-v1660

| | |
|---|---|
| PerRAInfo-r16 ::= | CHOICE { |
| perRASSBInfoList-r16 | PerRASSBInfo-r16, |
| perRACSI-RSInfoList-r16 | PerRACSI-RSInfo-r16 |

}

| | |
|---|---|
| PerRASSBInfo-r16 ::= | SEQUENCE { |
| ssb-Index-r16 | SSB-Index, |

| | |
|---|---|
| numberOfPreamblesSentOnSSB-r16 | INTEGER (1..200), |

| | |
|---|---|
| perRAAttemptInfoList-r16 | PerRAAttemptInfoList-r16 |

}

| | |
|---|---|
| PerRACSI-RSInfo-r16 ::= | SEQUENCE { |
| csi-RS-Index-r16 | CSI-RS-Index, |

| | |
|---|---|
| numberOfPreamblesSentOnCSI-RS-r16 | INTEGER (1..200) |

}

| PerRACSI-RSInfoExt-v1660 ::= | SEQUENCE { | |
|---|---|---|
| csi-RS-Index-v1660 | INTEGER (1..96) | OPTIONAL |

}

| PerRAAttemptInfoList-r16 ::= | SEQUENCE (SIZE (1..200)) OF PerRAAttemptInfo-r16 | |
|---|---|---|
| PerRAAttemptInfo-r16 ::= | SEQUENCE { | |
| contentionDetected-r16 | BOOLEAN | OPTIONAL, |

| | | |
|---|---|---|
| dIRSRPAboveThreshold-r16 | BOOLEAN | OPTIONAL, |

...,
[[

| | | |
|---|---|---|
| fallbackRAR-Received-r17 | BOOLEAN | OPTIONAL |

]]
}

The patent disclosure consider the 3GPP V17.2.0 version of TS 38.331, TS 38.321, TS 38.300 and TS 38.304 as relevant background for this invention.

GPP has discussed the optimization of RACH for feature specific random access and has decided that the UE can send the feature or the combination of features that triggered the RACH as well as the used feature combination to the gNB for self-optimization purposes. The UE also include NSAG ID when the applicable feature is slicing.

Mobility and Lower Layers Triggered Mobility: In wireless technologies like 5G NR, devices can move across different cells. Mobility is performed using a procedure called cell reselection in RRC_IDLE mode. Till NR R17, mobility is performed using a procedure called handover in RRC_CONNECTED mode. Network controlled mobility applies to UEs in RRC_CONNECTED. It requires explicit RRC signalling to be triggered by the gNB in NR. Handover in NR usually consists of three steps: handover preparation, handover execution and handover completion. gNB may configure the UE to report measurements and based on the reported measurements or based on its own understanding of the network topology, gNB will send RRC Reconfiguration message to handover the UE to another cell called target cell from the source cell. UE accesses the target cell and sends RRC Reconfiguration complete message. In an alternative way introduced in 3gpp NR release 16, gNB may configure the UE with the execution conditions for triggering handover and once the execution conditions are satisfied, the UE may move to target cell and sends the RRC Reconfiguration complete. 3gpp also introduced a new handover called DAPS handover in release 16. In all these methods, UE performs handover by sending layer 3 (RRC) messages which causes considerable signalling overhead and latency issues. We can refer to the handover, and conditional handover (CHO) as layer 3 mobility. In case of dual connectivity, UE may perform PSCellChange or Conditional PSCellChange. In the context of dual connectivity, we can refer PSCellChange or Conditional PSCellChange also as layer 3 mobility. i.e. Handover, Conditional Handover, PSCellChange, Conditional PSCellChange etc. refers to L3 mobility. We can also refer PSCellChange or Conditional PSCellChange as SCG layer 3 mobility and the handover and CHO as MCG layer 3 mobility in the context of dual connectivity. The UE may perform L3 mobility upon reception of the RRC reconfiguration message asking the UE to perform handover, or upon execution of the conditional reconfiguration (CHO, CPA (Conditional PSCell Addition) or CPC).

The 3GPP release 18 is considering Lower Layers (L1/L2 layers) Triggered Mobility, also known as LTM to solve the problem related to latency, signalling overhead etc. associated with layer 3 mobility. As per 3GPP, the goal of LTM is to enable a serving cell change via L1/L2 signalling, in order to reduce the latency, overhead and interruption time. Network (gNB) may configure the UE with multiple candidate cells to allow fast application of configurations for candidate cells. Network may further send MAC CE or L1 signalling to dynamically switch the UE from a source cell to one of the configured candidate cells. Further, LTM is triggered based on L1 measurements rather than L3 measurements.

The 3GPP proposes to perform LTM, without reset of lower layers like MAC to avoid data loss and to reduce the additional delay of data recovery wherever it is possible

The gNB may provide LTMCandidateConfiguration, i.e. configure LTM candidate cells through one RRCReconfiguration message for a candidate target cell or through one CellGroupConfig for each candidate target cell or through any similar RRC structure or IE containing the similar fields (for e.g. a new IE LTM-CandidateConfig can be defined as ASN.1 sequence containing CellGroupConfig and some other information elements in the RRCReconfiguration). gNB may further release or modify the candidate configurations. The UE may store the LTM configuration of other candidate cells even after moving to a candidate cell through LTM. gNB also may provide the UE with configuration for performing LTM measurements for different candidate frequencies and candidate cells and reporting based on the performed LTM measurements.

LTM measurements: The UE can be configured by the gNB with different measurement configurations for both layer 3 mobility (for e.g. using MeasConfig IE in R17 NR) and LTM. The UE which has been configured with measurement configurations for layer3 mobility (Measurements configured/performed/reported for layer 3 mobility for e.g. configured through R17 MeasConfig IE, is here in after referred as L3 measurements) and LTM (Measurements configured/performed/reported for LTM is here in after referred as LTM measurements), performs both L3 measurements and LTM measurements. LTM measurements are L1 measurements.

There are multiple ways by which L1 measurements for LTM can be provided to the UE. For e.g. 3gpp is considering three different ways for providing L1 measurements to the UE as below.
1. Configurations for L1 measurement RS is provided under ServingCellConfig for the serving cells
2. Configurations for L1 measurement RS is provided separately from ServingCellConfig for the serving cells and CellGroupConfig for the candidate cells
3. Configurations for L1 measurement RS is provided under CellGroupConfig for the candidate cells.

L1 measurement report for LTM is reported as periodic report on PUCCH, semi-persistent report on PUCCH/PUSCH, and aperiodic report on PUSCH. Further, L1 measurements can be reported using MAC CE. This reports may be scheduled by gNB or initiated by the UE. It is also possible that gNB can decide for LTM through UL measurements.

Cell Switch command: A gNB instructs UE to perform LTM, i.e. to move to target candidate cell through Downlink (DL) MAC CE or through L1 signaling. MAC CE triggering of the cell switch carries LTM related information for cell switch including the cell identifier. The procedure of triggering change of cells via the LTM feature is called cell switch. Both RACH-based (CFRA, CBRA) and RACH-less procedures for cell switch is supported. RACH-less cell switch may be used if the UE doesn't need to acquire TA during the cell switch. RACH resource for CFRA for cell switch can be provided in RRC configuration to the UE.

LTM cell switch is supervised by a timer. The UE arrival in the target cell will be indicated to the network by uplink signaling, either MAC signaling or RRC signaling. The timer which we refer as Tcellswitch is started when the UE receives cell switch command and is stopped once the cell switch is completed. In an option, Tcellswitch is defined as a new timer. In another option, existing NR RRC R17 timer T304 can be used for supervising LTM cell switch and all the embodiments for Tcellswitch in this invention are applicable for T304 when it is used for LTM, such as supervising LTM cell switch. Cell switch is completed once the UE successfully completes random access for RACH based cell switch. For RACH less cell switch, cell switch may be completed once a UL transmission is successful (for e.g. the UL transmission for indicating the in the target cell. In Release 18 NR, LTM is supported in dual connectivity, NR-DC also.

The gNB may configure the UE to perform random access towards one or more LTM candidate cells for receiving the timing advance (TA) before the cell switch is performed. The patent disclosure refers the random access as Early TA. gNB sends a PDCCH order to initiate RACH for TA measurement for candidate cells. PDCCH order is defined in various 3gpp specifications for physical layer and Layer 2. Random access performed on LTM candidate cells for the timing advance reception (for e.g. based on PDCCH order) is known as Random access for early TA. The UE receives PDCCH order from the serving cell. Upon reception of this PDCCH order, the UE initiates RACH for TA measurement for candidate cells on the one or more candidate cells. The UE sends RACH preamble to the candidate cells and receives the Timing Advance (TA) value from the candidate cell. TA for candidate cells may be received from the source cell also. Normally, TA will be received in the random access response (RAR), but it may be also received through a DL MAC CE such as the LTM Cell Switch Command Though early TA is used widely for LTM, it may be used for any type of mobility including the traditional handovers. The embodiments of this invention are applicable for such scenarios also.

The 3GPP specifications such as TS38.300, TS38.331, TS 38.321 etc. V17.4.0 as relevant background.

Referring now to the drawings, and more particularly to FIGS. 1 through 7 where similar reference characters denote corresponding features consistently throughout the figures, there are shown preferred embodiments.

FIG. 1 illustrates a wireless network (300) for performing random access for early timing advance, according to the embodiments as disclosed herein. The wireless network (300) can be, for example, but not limited to a fourth generation (4G) network, a fifth generation (5G) network, an Open Radio Access Network (ORAN) or the like. In an embodiment, the wireless network (300) includes a UE (100) and a network entity (200).

The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network entity (200) can be, for example, but not limited to a gNB, a eNB, a new radio (NR) trans-receiver, gNB CU, a gNB DU or the like.

The UE (100) informs capability information to the network entity (200), where the capability information indicates whether the UE (100) is capable for performing random access for early TA on at least one LTM candidate cell. Further, the UE (100) receives a configuration to perform random access towards the at least one LTM candidate cell for receiving the early TA. Further, the UE (100) receives a PDCCH order from a serving cell to perform the random access towards the at least one LTM candidate cell for receiving the early timing advance. Further, the UE (100) performs random access towards the at least one LTM candidate cell for receiving the early timing advance. Further, the UE (100) logs and reports random access related information about the performed random access.

In an embodiment, the UE (100) which has performed random access for TA measurement for the LTM candidate cells, and has transmitted the maximum number of RA preambles (for e.g. PREAMBLE_TRANSMISSION_COUNTER becomes equal to preamble TransMax+1, whereas PREAMBLE_TRANSMISSION_COUNTER and preambleTransMax are as defined in TS 38.321/TS 38.331), but has not succeeded, considers the random access procedure (as described in TS 38.321 MAC specification v17.4.0) as unsuccessfully completed. In an embodiment, the transmission of random access preambles for early TA is considered as not succeeded, if the UE (100) has not successfully received a random access response or a MAC CE which provides the timing advance or any other relevant response.

In an embodiment, the UE (100) performs random access for early TA for L3 mobility (handover, conditional handover, PSCell Addition, PSCellChange) also. In an embodiment the UE (100) informs the network entity (200) whether it is capable of performing random access for early TA for L3 mobility. In an embodiment, the UE (100) informs the network entity (200) whether it is capable of performing random access for early TA for L3 conditional mobility. In an embodiment the UE (100) informs the network entity (200) whether it is capable of performing random access for early TA for MCG mobility. In an embodiment, the UE (100) informs the network entity (200) whether it is capable of performing random access for early TA for MCG conditional mobility. In an embodiment, the UE (100) informs the network entity (200) whether it is capable of performing random access for early TA for SCG mobility. In an embodiment, the UE (100) informs the network entity (200) whether it is capable of performing random access for early TA for SCG conditional mobility.

In an embodiment, when the UE MAC layer has transmitted maximum number of random access preambles for early TA, but the RACH for early TA has not succeeded, the UE (100) skips reporting the Random Access Problem to upper layers and a UE RRC doesn't declare a RLF on the cell group (e.g., MCG/SCG) where the maximum number of RA preambles for early TA is send. A sample set of changes according to TS 38.321 is given below:

### 5.1.3 Random Access Preamble Transmission

### <Some Text>

1> if LBT failure indication is received from lower layers for this Random Access Preamble transmission:
2> if lbt-FailureRecoveryConfig is configured:
3> perform the Random Access Resource selection procedure (see clause 5.1.2).
2> else:
3> increment PREAMBLE_TRANSMISSION_COUNTER by 1;
3> if PREAMBLE_TRANSMISSION_COUNTER=preambleTransMax+1:
4> if the Random Access Preamble is transmitted on the SpCell:
5> indicate a Random Access problem to upper layers;
5> if this Random Access procedure was triggered for SI request:
6> consider the Random Access procedure unsuccessfully completed.
4> else if the Random Access Preamble is transmitted on an SCell or on a LTM candidate cell:
5> consider the Random Access procedure unsuccessfully completed.

### 5.1.4 Random Access Response Reception

Once the Random Access Preamble is transmitted and regardless of the possible occurrence of a measurement gap, the MAC entity shall:

### <Some not Relevant Text>

1> if ra-Response Window configured in BeamFailureRecoveryConfig expires and if a PDCCH transmission on the search space indicated by recoverySearchSpaceId addressed to the C-RNTI has not been received on the Serving Cell where the preamble was transmitted; or
1> if ra-Response Window configured in RACH-ConfigCommon expires, and if the Random Access Response containing Random Access Preamble identifiers that matches the transmitted PREAMBLE_INDEX has not been received:
2> consider the Random Access Response reception not successful;
2> increment PREAMBLE_TRANSMISSION_COUNTER by 1;
2> if PREAMBLE_TRANSMISSION_COUNTER=preambleTransMax+1:
3> if the Random Access Preamble is transmitted on the SpCell:
4> indicate a Random Access problem to upper layers;
4> if this Random Access procedure was triggered for SI request:
5> consider the Random Access procedure unsuccessfully completed.
3> else if the Random Access Preamble is transmitted on an SCell or on a LTM candidate cell:
4> consider the Random Access procedure unsuccessfully completed.

Further, the UE (100) doesn't initiate RRC Reestablishment, MCGFailureInformation or SCGFailureInformation procedures for the unsuccessful completion when the random access was performed for Early Timing Advance (TA) for LTM candidate cells.

In an embodiment, the UE (100) which has performed random access for TA measurement for one or more LTM candidate cells (RA for early TA), and the UE (100) has not received the timing advance for the candidate cell through random access response (for e.g. due to the random access procedure was not successful, like not reception of RAR or MSGB, contention and other causes), and has received the cell switch command for performing LTM to one of those candidate cells, initiates random access procedure and sends PRACH upon the reception of cell switch command.

In an embodiment, the UE (100) which has performed random access for TA measurement for the one or more LTM candidate cells (RA for Early TA). The UE (100) receives the cell switch command for the LTM to the same or different candidate cells or L3 handover command such as ReconfigurationWithSync for same or different target cells or the modification of LTM configuration in which the candidate cells are released. The UE (100) cancels waiting for the timing advance in RAR or UL MAC CE.

In an embodiment, the UE (100) which has performed random access for TA measurement for the one or more LTM candidate cells and received timing advance. The UE (100) discards the received timing advance if it receives a new indication from the network to transmit another random access for Timing Advance measurements. The indication could be a PDCCH order.

In an embodiment, the network entity (200) (e.g., gNB or the like) doesn't configure the UE (100) for performing the random access for early TA on LTM candidate cells, if the UE (100) needs gaps for performing the same. In an example embodiment, if the candidate cells are on a different frequency than the serving frequency, the gNB doesn't configure the UE (100) for performing random access for early TA on LTM candidate cells. In an example embodiment, if the candidate cells are on the same frequency as the serving frequency (intrafrequency candidate) but the BWP of the candidate cell or the part of BWP of the candidate cell where the random access resources are configured is not completely contained within the serving cell's BWP, the gNB doesn't configure the UE (100) for performing random access for early TA on the LTM candidate cells. In an embodiment, the UE (100) informs the gNB whether it is capable for performing random access for early TA on the LTM candidate cells. In an embodiment, the capability is informed using a single bit of per-UE capability in UE Capability Information message. In an embodiment, the capability is informed using a single bit of per-FR capability in UE Capability Information message. In an embodiment, the capability is informed using the single bit of per-band capability in UE Capability Information message. In an embodiment, the capability is informed using the needForGapsInfo IE in RRC messages such as RRCReconfigurartionComplete and RRCResumeComplete. In an embodiment, the UE (100) sends the information in the existing capability IEs interFrequencyMeas-NoGap-r16. In an embodiment, the UE (100) send interFrequencyMeas-NoGap-r16 to indicate if the UE (100) is capable of performing Random access for early TA without a gap.

In an embodiment (as shown in FIG. 2), the gNB CU (200a) informs the gNB DU (200b) whether the gNB DU (200b) can configure the UE (100) for performing early TA. This is informed in the RRC InterNodeMessages such as CG-ConfigInfo. In an embodiment, the gNB DU (200b) informs the UE (100) about the configuration for early TA including the resources, gaps etc. The gNB DU may directly include the configuration in IEs such as CellGroupConfig send to the UE (100) or it may send the configuration to the UE (100) through gNB CU. The gNB CU stands for any node which performs similar functionalities as gNB CU in a network entity. Similarly, the gNB DU stands for any node which performs similar functionalities as gNB DU in a network entity.

In an embodiment, the gNB CU (200a) informs the gNB DU (200b) whether the gNB DU (200b) can configure the UE (100) for performing early TA for the candidate cell or for the candidate frequency. The gNB DU configures the UE (100) for early TA accordingly. The gNB DU may directly configure the UE (100) through IEs such as CellGroupConfig or it may configure the UE (100) through gNB CU.

In an embodiment, the gNB configures the random access resources for early TA so that it overlaps in time domain with a SS/PBCH Block Measurement Timing Configuration (SMTC). In an embodiment, the network entity (e.g., gNB) (200) configures the random access resources for early TA so that it overlaps in time domain with the SSB timing.

In an embodiment, the network entity (e.g., gNB) (200) configures the UE (100) with separate CFRA resources for early TA and for the LTM cell switch execution. The network entity (e.g., gNB) (200) informs the UE (100) that a set of CFRA (Contention Free Random Access) resources are for early TA and a set of CFRA resources are for LTM cell switch execution. In an embodiment, the network entity (e.g., gNB) (200) may configure the same set of CFRA resources for early TA and LTM cell switch execution. In an embodiment, network entity (e.g., gNB) (200) may configure CFRA resources for early TA and the UE (100) doesn't use CFRA resources for cell switch execution, and the UE (100) may use CBRA (Contention Based Random Access) resources for cell switch execution.

In an embodiment, if the UE (100) needs gaps for performing the random access for early TA on LTM candidate cells, it uses the configured measurement gaps. In an embodiment, the UE (100) performs random access for early TA on the LTM candidate cell during the configured measurement gap. In an embodiment, the UE (100) sends Random access preamble for early TA on the LTM candidate cell during the configured measurement gap. In an embodiment, the UE (100) waits for the response containing timing advance of the candidate cells (e.g. random access response, DL MAC CE etc.) for early TA of the LTM candidate cell during the configured measurement gap. In an embodiment, the UE (100) avoids using the measurement gap for performing measurements when the measurement gaps are used for performing random access for early TA on the LTM candidate cells. Further, the Gaps could be configured through any of the embodiments below.

In an embodiment, if the UE (100) needs the gaps for performing the random access for early TA on the LTM candidate cells, the UE (100) may use the configured MUSIM gaps.

In an embodiment, if the UE (100) needs gaps for performing the random access for early TA on the LTM candidate cells, the UE (100) may use the configured FR2UL gaps.

In an embodiment, if the UE (100) needs gaps for performing the random access for early TA on LTM candidate cells, the UE (100) may use the gap configured for any other purpose such as positioning measurement gaps, MUSIM gaps, FR2UL gaps, NTN gaps etc. In an embodiment, the network entity (e.g., gNB) (200) informs the UE (100) whether it can use the gaps configured for another purpose for early TA.

In an embodiment, if the UE (100) needs the gaps for performing the random access for early TA on the LTM candidate cells, the network entity (e.g., gNB) (200) configures the UE gaps for early TA on LTM candidate cell and the UE uses the configured gaps. In an embodiment, the UE (100) performs random access for early TA on the LTM candidate cell during this configured gap. In an embodiment, the UE (100) sends Random access preamble for early TA on the LTM candidate cell during this configured gap. In an embodiment, the UE (100) waits for the response containing timing advance of the candidate cells (e.g. random access response, DL MAC CE etc.) for early TA of the LTM candidate cell during this configured gap. In an embodiment, this gap could be used only for early TA.

In an embodiment, a NR UE (for example) which needs gaps for performing the random access for early TA on the LTM candidate cells, uses the measurement gaps configured through gap UE or gapFR1 or gapFR2 (i.e. the gaps configured without a gap identifier) for performing the random access for early TA on LTM candidate cells.

In an embodiment, the NR UE, which needs gaps for performing the random access for early TA on the LTM candidate cells, uses the measurement gaps configured through GapConfig-r17 for performing the random access for early TA on the LTM candidate cells. In an embodiment, the network entity (e.g., gNB) (200) informs the UE (100) about the measurement gap identifier (such as MeasGapId-r17) to be used for performing the random access for early TA on LTM candidate cells. In an embodiment, the network entity (e.g., gNB) (200) informs the UE (100) about the measurement gap identifier (such as MeasGapId-r17) to be used for performing the random access for early TA on all the LTM candidate cells of a frequency. In an embodiment, the network entity (e.g., gNB) (200) informs the UE (100) about the measurement gap identifier (such as MeasGapId-r17) to be used for performing the random access for early TA on each LTM candidate cell. In an embodiment, this information on the measurement gap identifier as in above embodiments may be provided within the UL BWP configuration. In an embodiment, this information on the measurement gap identifier as in above embodiments may be provided within the RACH configuration, such as RACH-ConfigCommon structure in NR RRC specification.

In an embodiment, when multiple measurement gaps are configured, the UE (100), which needs gaps for performing the random access for early TA on the LTM candidate cells, chooses one of the measurement gap to be used for performing early TA based on its own internal algorithms and uses the same for performing early TA on LTM candidate cells.

In an embodiment, when multiple measurement gaps are configured for the UE and one or more measurement gaps are configured to be used for the candidate cell for which the UE (100) need to perform early TA, the UE (100), which needs gaps for performing the random access for early TA on the LTM candidate cells, choses the measurement gap or one of the measurement gaps configured for the same candidate cell and uses it for performing early TA based on its own internal techniques.

In an embodiment, the NR UE, which needs gaps for performing the random access for early TA on LTM candidate cells, uses the measurement gaps configured through gapToAddModList-r17 for performing the random access for early TA on the LTM candidate cells.

In an example embodiment, if the candidate cells are on a different frequency than the serving frequency, the UE (100), which needs gaps for performing the random access for early TA on LTM candidate cells, uses the measurement gaps configured for performing random access for early TA on LTM candidate cells. In an example embodiment, if the candidate cells are on the same frequency as the serving frequency (intrafrequency candidate) but the BWP of the candidate cell or the part of BWP of the candidate cell where the random access resources are configured is not completely contained within the serving cell's BWP, the UE (100) uses the measurement gaps configured for the intra frequency measurements.

In an embodiment, the NR UE which needs gaps for performing the random access for early TA on LTM candidate cells and is configured with the gap for performing the random access for early TA on LTM candidate cells considers that gap as having higher priority than any other gap while using the gap for performing random access for early TA.

In an embodiment, the NR UE which needs gaps for performing the random access for early TA on the LTM candidate cells and is configured with the gap for performing the random access for early TA on the LTM candidate cells avoids using any other gap which is overlapping completely or partially with the gap which is needed for performing the random access for early TA on LTM candidate cells while using the gap for performing random access for early TA.

In an embodiment, the NR UE, which needs gaps for performing the random access for early TA on LTM candidate cells and is configured with the gap for performing the random access for early TA on the LTM candidate cells, skips using the gap for measurements (or for any other activities such as body proximity sensing or MUSIM operations) while using that gap for performing random access for early TA.

In an embodiment, the NR UE, which needs gaps for performing the random access for early TA on the one or more of LTM candidate cells, is configured with the gap configuration for performing the early TA. In an embodiment, the gap will be used ex-clusively for performing random access for early TA. In an embodiment, the network entity (e.g., gNB) (200) provides the gap such that gap occurrence and the occurrence of the configured CFRA resources are at the same time.

In an embodiment, the network entity (e.g., gNB) (200) configures the UE (100) and the gaps for early TA as preconfigured gaps. In an embodiment, the preconfigured gaps configured for early TA are deactivated by default. In an embodiment, the network entity (e.g., gNB) (200) informs the UE (100) about the candidate cells or frequencies for which early TA can be performed using the preconfigured gaps. In an embodiment, the network entity (e.g., gNB) (200) informs the UE (100) about the candidate cells or frequencies for which early TA can be performed using one or more specific preconfigured gaps. In an embodiment, the preconfigured gap for early TA for the candidate cell or for the frequencies for the candidate cells will be activated upon receiving the PDCCH order for RACH for TA measurement for the corresponding candidate cells. In an embodiment, the preconfigured gap for early TA for the candidate cell or for the frequencies for the candidate cells will be deactivated upon receiving the timing advance for the corresponding candidate cells.

In an embodiment, the network entity (e.g., gNB) (200) configures the UE (100) with the gaps for the early TA such that they overlap with configured RA resource. In an embodiment, the network entity (e.g., gNB) (200) may configure the UE (100) with NCSG for the early TA.

In an embodiment, the network entity (e.g., gNB) (200) configures the NR UE about the RA resources for early TA for a candidate cell or a candidate frequency such that they overlap with the gap occurrence.

In an embodiment, the network entity (e.g., gNB) (200) configures the NR UE about the gaps and the CFRA resources for early TA using RRCReconfiguration or RRCResume messages. In an embodiment, the network entity (e.g., gNB) (200) adds/modifies/releases the gaps and the CFRA resources for early TA for a NR UE using RRCReconfiguration or RRCResume messages.

In an embodiment, in a dual connectivity if the earlyTA is configured for the LTM candidate cells on the SCG, a secondary node (SN) informs that early TA is configured for the LTM candidate cells on the SCG. In an embodiment, in the dual connectivity, if the early TA is configured for the LTM candidate cells on the SCG, the SN informs that early TA is configured for LTM candidate cells on the SCG, when the early TA requires gaps. In an embodiment, in the dual connectivity, if early TA is configured for the LTM candidate cells on the SCG and if that early TA requires gaps, the SN informs the master node (MN) the list of LTM candidate cells and the LTM candidate cell configuration and the information of the configured random access resources on the LTM candidate cells for which early TA is configured. MN allocates the gaps so that the UE (100) could perform early TA during the gap and informs the SN in RRC InterNodeMessages such as CG-ConfigInfo.MN also informs the UE (100) the gap to be used for early TA.

In an embodiment, in the dual connectivity, the SN doesn't configure the UE (100) for performing random access for early TA on the LTM candidate cells, if the UE (100) needs the gaps for performing the same. In an embodiment, the SN CU informs a SN DU if it can configure the UE (100) for early TA.

In an embodiment, in the dual connectivity, if earlyTA is configured for the LTM candidate cells on the SCG, the MN informs the SN the gaps for the early TA for LTM candidate cells in the SCG, when this early TA requires the gaps.

In an embodiment, the UE (100), which has performed random access for TA measurement (early TA) for the candidate cells in the LTM, logs and reports to network entity (e.g., gNB) (200) that the random access is performed for the TA measurement for the LTM candidate cell, for self-optimisation purposes. In an embodiment, the NR UE which has performed random access for early TA, informs gNB that the random access is due to early TA through raPurpose field in RA-Report. The NR UE sets the ra-purpose-r16 to earlyTA (or any other value which communicates that the random access is performed for LTM due to earlyTA) for this case. In an embodiment, UE uses a spare value in the ra-purpose-r16 IE to inform the gNB that random access is performed for earlyTA.

In an embodiment, the above leads to below example changes in TS 38.331.

| | |
|---|---|
| RA-Report-r16 ::= | SEQUENCE { |
| cellId-r16 | CHOICE { |
| cellGlobalId-r16 | CGI-Info-Logging-r16, |
| pci-arfcn-r16 | PCI-ARFCN-NR-r16 |

},

| | |
|---|---|
| ra-InformationCommon-r16 | RA-InformationCommon-r16 |

OPTIONAL,

| | |
|---|---|
| raPurpose-r16 | ENUMERATED {accessRelated, beamFailureRecovery, |

reconfigurationWithSync, ulUnSynchronized,

schedulingRequestFailure,

noPUCCHResourceAvailable, requestForOtherSI,

msg3RequestForOtherSI-r17,earlyTA,

spare7, spare6, spare5, spare4, spare3,

spare2, spare 1},

```
  ...,
  [[
```

| | |
|---|---|
| spCellID-r17 | CGI-Info-Logging-r16 |

OPTIONAL
]]
}

raPurpose: This field is used to indicate the RA scenario for which the RA report entry is triggered. The RA accesses associated to the initial access from a RRC_IDLE and RRC re-establishment procedure, transition from an RRC-INACTIVE. The indicator beamFailureRecovery is used in case of successful beam failure recovery related RA procedure in the SpCell. The indicator reconfiguration WithSync is used if the UE (100) executes a reconfiguration with sync. The indicator ulUnSynchronized is used if the random access procedure is initiated in a SpCell by downlink (DL) or uplink (UL) data arrival during RRC_CONNECTED when the timeAlignmentTimer is not running in the PTAG or if the RA procedure is initiated in a serving cell by a PDCCH order. The indicator schedulingRequestFailure is used in case of SR failures. The indicator noPUCCHResourceAvailable is used when the UE (100) has no valid SR PUCCH resources configured. The indicator requestForOtherSI is used for MSG1 based on demand SI request. The indicator msg3RequestForOtherSI is used in case of MSG3 based SI request. The field can also be used for the SCG-related RA-Report when the raPurpose is set to beamFailureRecovery, reconfiguration WithSync, ulUnSynchronized, schedulingRequestFailure noPUCCHResourceAvailable and earlyTA. RA purpose earlyTA used if randomaccess is performed for the TA measurement for a LTM candidate cell.

In an embodiment, the UE (100), which has performed random access for early TA measurement for the LTM candidate cells, logs and reports the candidate cell index of the LTM candidate cell. In an embodiment, the UE (100), which has performed random access for the TA measurement for the candidate cells, logs and reports the cell identifier of the candidate cell (which could be one of physical cell identifier (PCI), a combination of NR-ARFCN and PCI, global cell identifier, the bits received in DCI format 1_0 for PDCCH order, LTM candidate cell index or any other identifier which helps the network to identify the LTM candidate cell) for which random access is performed for the TA measurement for the candidate cell.

In an embodiment, the UE (100), which has performed random access for early TA measurement for LTM candidate cells, logs and reports the cell identifier of the source cell which could be one of the physical cell identifier, a combination of NR-ARFCN and PCI, the global cell identifier, the LTM candidate cell index or any other identifier which helps the network entity (200) to identify the candidate cell. In an embodiment, the UE (100) also logs and reports the cell identifier of the cell which send a PDCCH order for TA measurement for the candidate cells.

In an embodiment, the UE (100), which has performed random access for early TA measurement for L3 mobility, logs and reports the cell identifier of the source cell which could be one of the physical cell identifier, a combination of NR-ARFCN and PCI, the global cell identifier etc. In an embodiment, the UE (100) also logs and reports the cell identifier of the cell which send a PDCCH order for TA measurement for the candidate cells. The UE (100) also may log and report the cell identifier of the target cell (which could be one of physical cell identifier (PCI), a combination of NR-ARFCN and PCI, global cell identifier, the bits received in DCI format 1_0 for PDCCH order, candidate cell index or any other identifier which helps the network to identify the target cell) for which random access is performed for the TA measurement for the target cell.

In an embodiment, the UE (100), which has performed random access for early TA measurement for L3 conditional mobility, logs and reports the cell identifier of the source cell which could be one of the physical cell identifier, a combination of NR-ARFCN and PCI, the global cell identifier, the candidate cell index or any other identifier which helps the network entity (200) to identify the candidate cell. In an embodiment, the UE (100) also logs and reports the cell identifier of the cell which send a PDCCH order for TA measurement for the candidate cells. UE also may log and report the cell identifier of the candidate cell (which could be one of physical cell identifier (PCI), a combination of NR-ARFCN and PCI, global cell identifier, the bits received in DCI format 1_0 for PDCCH order, candidate cell index or any other identifier which helps the network to identify the candidate cell) for which random access is performed for the TA measurement for the candidate cell

Upon receiving the reason for the random access as TA measurement for the candidate cell and additional information such as the cell identifiers, the network entity (e.g., gNB) (200) optimises various random access parameters of early TA.

In an embodiment, the UE (100), which has performed random access for early Timing Advance (TA) measurement for LTM candidate cells, skips the logging information about such a random access procedure or such a random access attempt in the RA-Report. In an embodiment, the UE (100), which has performed random access for Timing Advance (TA) measurement for LTM candidate cells, skips the logging information about such a random access procedure or such a random access attempt in the RLF-Report or CEF report.

FIG. 2 illustrates another wireless network (300) for performing random access for early TA, according to the embodiments as disclosed herein. The wireless network (300) includes the gNB centralized unit (CU) (200a) informing the gNB distributed unit (DU) (200b) whether the gNB DU (200b) configures the UE (100) for performing the early TA for the candidate cell. The gNB DU (200b) configures the configuration for random access for early timing advance in the wireless network (300) in response to informing.

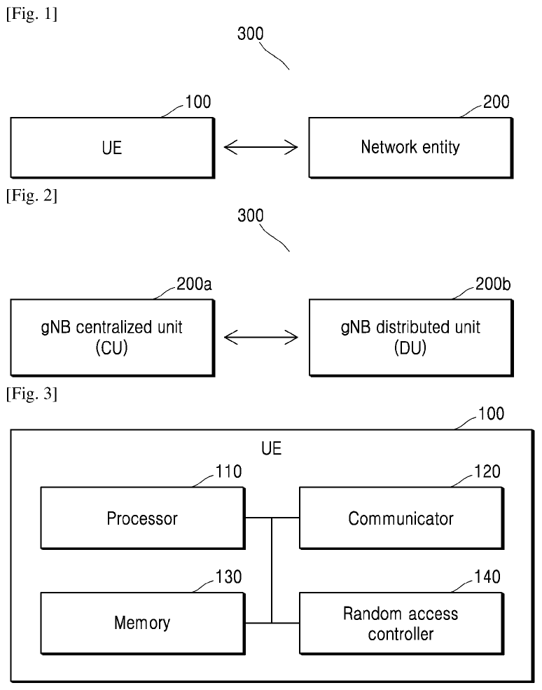

FIG. 3 shows various hardware components of the UE (100), according to the embodiments as disclosed herein. In an embodiment, the UE (100) includes a processor (110), a communicator (120), a memory (130) and a random access controller (140). The processor (110) is coupled with the communicator (120), the memory (130) and the random access controller (140).

The random access controller (140) informs the capability information to the network entity (200), where the capability information indicates whether the UE (100) is capable for performing random access for early TA on the at least one LTM candidate cell. In an embodiment, the capability information is informed using the single bit of per-UE capability in the UE capability information message.

Further, the random access controller (140) receives the configuration to perform random access towards the at least one LTM candidate cell for receiving the early TA. In an embodiment, the configuration to perform the random access includes contention free random access (CFRA) resources, where the CFRA resources are separate from the CFRA resources provided for performing the cell switch.

Further, the random access controller (140) receives the PDCCH order from a serving cell to perform the random access towards the at least one LTM candidate cell for receiving the early timing advance. Further, the random access controller (140) performs the random access towards the at least one LTM candidate cell for receiving the early timing advance. Further, the random access controller (140) logs and reports the random access related information about the performed random access.

In an embodiment, the random access related information for the early timing advance includes at least one of: the candidate cell index or the cell identifier of the at least one LTM candidate cell for which random access is performed for the early TA measurement, and the cell identifier of the source cell and the information in which the random access is performed for receiving the early timing advance.

In an embodiment, the information in which the random access is performed for receiving the early timing advance is provided through a raPurpose field in a RA-Report. In another embodiment, the information in which the random access is performed for receiving the early timing advance is included in a SCG-related RA report. In an embodiment, the cell identifier is at least one of: a physical cell identifier and a NR-ARFCN (New Radio Absolute Radio Frequency Channel Number), and a global cell identifier.

In an embodiment, the random access controller (140) reports the random access related information for receiving the early timing advance in at least one of: the random access report, the radio link failure report, the connection establishment failure report, the successful handover report and the successful PSCellAddition or the Change report.

The random access controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In an embodiment, the communicator (120) includes an electronic circuit specific to a standard that enables wired or wireless communication. The communicator (120) is configured to communicate internally between internal hardware components of the UE (100) and with external devices via one or more networks.

Although the FIG. 3 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

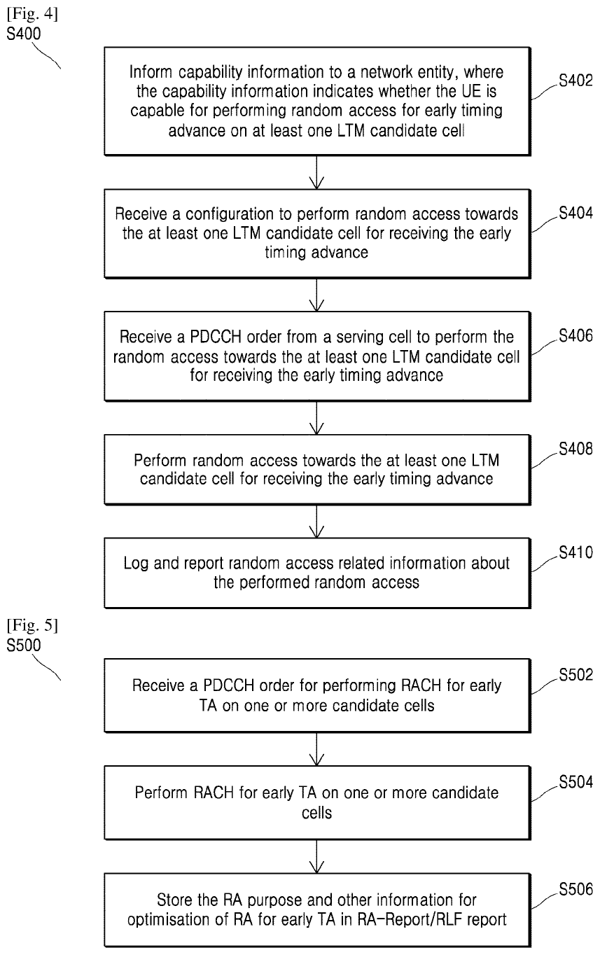

FIG. 4 is a flow chart (S400) illustrating a method, implemented by the UE (100), for performing the random access for the early TA, according to the embodiments as disclosed herein. The operations (S402-S410) are handled by the random access controller (140).

At S402, the method includes informing the capability information to the network entity (200). The capability information indicates whether the UE (100) is capable for performing random access for early TA on the at least one LTM candidate cell. At S404, the method includes receiving the configuration to perform random access towards the at least one LTM candidate cell for receiving the early TA. At S406, the method includes receiving the PDCCH order from the serving cell to perform the random access towards the at least one LTM candidate cell for receiving the early timing advance. At S408, the method includes performing the random access towards the at least one LTM candidate cell for receiving the early timing advance. At S410, the method includes logging and reporting the random access related information about the performed random access.

FIG. 5 is a flow chart (S500) illustrating operations performed for random access channel (RACH) for early TA, according to an embodiment disclosed herein. The operations (S502-S506) are handled by the random access controller (140).

At S502, the method includes receiving the PDCCH order for performing RACH for early TA on the one or more candidate cells. At S504, the method includes performing the RACH for early TA on the one or more candidate cells. At S506, the method includes storing the RA purpose and other information for optimisation of RA for early TA in RA-Report/RLF report.

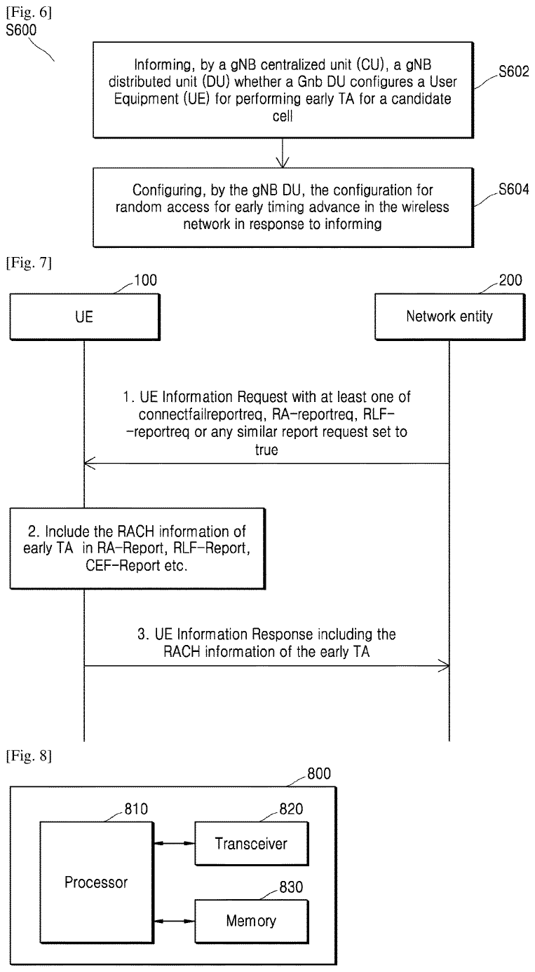

FIG. 6 is a flow chart (S600) illustrating a method, implemented by the wireless network (300), for performing random access for early timing advance, according to the embodiments as disclosed herein.

At S602, the method includes informing, by the gNB CU (200a), the gNB DU (200b) whether the gNB DU (200b) configures the UE (100) for performing early TA for the candidate cell. At S604, the method includes configuring, by the gNB DU (200b), the configuration for random access for early timing advance in the wireless network (300) in response to informing.

FIG. 7 is a sequence diagram illustrating operations performed for the RACH for early the TA, according to an embodiment disclosed herein.

At step 1, the UE (100) receives the UE Information Request with at least one of con-nectfailreportreq, RA-reportreq, RLF-reportreq or any similar report request set to true from the network entity (200). At step 2, the UE (100) includes the RACH information of early TA in the RA-Report, the RLF-Report, and the CEF-Report etc. At step 3, the UE (100) sends the UE Information Response including the RACH information of the early TA to the network entity (200). On receiving the RACH report, the gNB CU (200a) may send it to the gNB DU (200b) or the Operations, Administration and Maintenance (OAM) Self-organizing Networks (SON) module or may directly use it for optimizing various parameters related to random access. For example, the number of preambles, configuration of group A and group B preambles, RACH prioritization information, contention resolution timer, number of RACH preambles for 2 step RACH, PUSCH related parameters for 2 step RACH etc. A detailed description of the various parameters that can be present in the random access report is given below.

TABLE 1
defines RA-Report field descriptions:
RA-Report field descriptions
cellID
This field indicates the CGI of the cell in which the associated
random access procedure was performed.
contentionDetected
This field is used to indicate that contention was detected for the transmitted preamble
in the given random access attempt or not. This field is not included when the UE
performs random access attempt is using contention free random-access resources or
when the raPurpose is set to requestForOtherSI or when the RA attempt is a 2-step RA
attempt and fallback to 4-step RA did not occur (i.e. fallbackToFourStepRA is not
included).
csi-RS-Index, csi-RS-Index-v1660
This field is used to indicate the CSI-RS index corresponding to
the random access attempt.
If the random access procedure is for beam failure recovery, the field indicates the NZP-
CSI-RS-Resourceld. For CSI-RS index larger than maxNrofCSI-RS-ResourcesRRM-
1, the index value is the sum of csi-RS-Index (without suffix) and csi-RS-Index-v1660.
dlPuthlossRSRP
Measeured RSRP of the DL pathloss reference obtained at the time of RA_Type
selection stage of the RA procedure as captured in TS 38.321.
dlRSRP Above Threshold
In 4 step random access procedure, this field is used to indicate whether the DL beam
(SSB) quality associated to the random access attempt was above or below the
threshold rsrp-ThresholdSSB in beamFailureRecoveryConfig in UL BWP
configuration of UL BWP selected for random access procedure initiated for beam
failure recovery; Otherwise, rsrp-ThresholdSSB in rach-ConfigCommon in UL BWP
configuration of UL BWP selected for random access procedure.
In 2 step random access procedure, this field is used to indicate whether the DL beam
(SSB) quality associated to the random access attempt was above or below the
threshold msgA-RSRP-ThresholdSSB in rach-ConfigCommonTwoStepRA in UL BWP
configuration of UL BWP selected for random access procedure.
fallbackToFourStepRA
This field indicates if a fallback indication in MsgB is received (according to TS
38.321) for the 2-step random access attempt.
intendedSIBs
This field indicates the SIB(s) the UE wanted to receive as a result of the on demand
SI request (when the RA procedure is a used as a SI request) initiated by the UE. That
is, it indicates the one(s) of the SIB(s) in the SI message(s) requested to be broadcast
that the UE was interested in.
msg1-SCS-From-prach-ConfigurationIndex
This field is set by the UE with the corresponding SCS for CBRA as derived from the
prach-ConfigurationIndex in RACH-ConfigGeneric when the msg1-
SubcarrierSpacing is absent; otherwise, this field is absent.
msg1-SCS-From-prach-ConfigurationindexCFRA
This field is set by the UE with the corresponding SCS for CFRA as derived from the
prach-ConfigurationIndex in RACH-ConfigGeneric when the msg1-
SubcarrierSpacing is absent; otherwise, this field is absent.
msgA-PUSCH-PayloadSize
This field indicates the size of the overall payload available in the UE buffer at the time
of initiating the 2 step RA procedure. The value refers to the index of TS 38.321, table
6.1.3.1-1, corresponding to the UE buffer size.
msgA-RO-FDM
This field indicates the number of msgA PRACH transmission occasions Frequency-
Division Multiplexed in one time instance for the PRACH resources configured for 2-
step CBRA.
msgA-RO-FDMCFRA
This field indicates the number of msgA PRACH transmission occasions Frequency-
Division Multiplexed in one time instance for the PRACH resources configured for 2-
step CFRA.
msgA-RO-FrequencyStart
This field indicates the lowest resource block of the contention based random-access
resources for 2-step CBRA in the random-access procedure. The indication has the
form of the offset of the lowest PRACH transmissions occasion with respect to PRB 0
in the frequency domain.
msgA-RO-FrequencyStartCFRA
This field indicates the lowest resource block of the contention free random-access
resources for the 2-step CFRA in the random-access procedure. The indication has the
form of the offset of the lowest PRACH transmissions occasion with respect to PRB 0
in the frequency domain.
msgA-SCS-From-prach-ConfigurationIndex
This field is set by the UE with the corresponding SCS as derived from the msgA-
PRACH-ConfigurationIndex in RACH-ConfigGenericTwoStepRA (see tables Table
6.3.3.1-1, Table 6.3.3.1-2, Table 6.3.3.2-2 and Table 6.3.3.2-3, TS 38.211) when the
msgA-SubcarrierSpacing is absent and when only 2-step random-access resources are
available in the UL BWP used in the random-access procedure; otherwise, this field is
absent.
numberOfPreamblesSentOnCSI-RS
This field is used to indicate the total number of successive RA preambles that were
transmitted on the corresponding CSI-RS.
numberOfPreamblesSentOnSSB
This field is used to indicate the total number of successive RA preambles that were
transmitted on the corresponding SS/PBCH block.
onDemandSISuccess
This field is set to true when the RA report entry is included because of either msg1
based on demand SI request or msg3 based on demand SI request and if the on-demand
SI request is successful. Otherwise, the field is absent.
perRAAttemptInfoList
This field provides detailed information about a random access attempt.
perRACSI-RSInfoList
This field provides detailed information about the successive random access attempts
associated to the same CSI-RS.
perRASSBInfoList
This field provides detailed information about the successive random access attempts
associated to the same SS/PBCH block.
ra-InformationCommon
This field is used to provide information on random access attempts. This field is
mandatory present.
raPurpose
This field is used to indicate the RA scenario for which the RA report entry is triggered.
The RA accesses associated to Initial access from RRC_IDLE, RRC re-establishment
procedure, transition from RRC-INACTIVE. The indicator beamFailureRecovery is
used in case of successful beam failure recovery related RA procedure in the SpCell.
The indicator reconfigurationWithSync is used if the UE executes a reconfiguration
with sync. The indicator ulUnSynchronized is used if the random access procedure is
initiated in a SpCell by DL or UL data arrival during RRC_CONNECTED when the
timeAlignmentTimer is not running in the PTAG or if the RA procedure is initiated in
a serving cell by a PDCCH order. The indicator schedulingRequestFailure is used in
case of SR failures. The indicator noPUCCHResourceAvailable is used when the UE
has no valid SR PUCCH resources configured. The indicator requestForOtherSI is
used for MSGI based on demand SI request. The indicator msg3RequestForOtherSI is
used in case of MSG3 based SI request. The field can also be used for the SCG-related
RA-Report when the raPurpose is set to beamFailureRecovery,
reconfigurationWithSync, ulUnSynchronized, schedulingRequestFailure and
noPUCCHResourceAvailable.
spCellID
This field is used to indicate the CGI of the SpCell of the cell group associated to the
SCell in which the associated random access procedure was performed. If the UE
performs RA procedure on a SCell associated to the MCG, then this field is set to the
CGI of the PCell and if the UE performs RA procedure on a SCell associated to the
SCG, then this field is set to the CGI of the PSCell. If the CGI of the PSCell is not
available at the UE for the RA procedure performed on a SCell associated to the SCG
or for the RA procedure on the PSCell, this field is set to the CGI of the PCell.
Otherwise, the field is absent.
ssb-Index
This field is used to indicate the SS/PBCH index of the SS/PBCH block corresponding
to the random access attempt.
ssbsForSI-Acquisition
This field indicates the SSB(s) (in the form of SSB index(es)) that the UE used to receive
the requested SI message(s). The field is present if the purpose of the random access
procedure was to request on-demand SI (i.e. if the raPurpose is set to
requestForOtherSI or msg3RequestForOtherSI). Otherwise, the field is absent.

In accordance with an embodiment of the disclosure, a method for optimizing random access in a wireless network (300) is disclosed. The method may comprise: informing, by a User Equipment (UE) (100), capability information to a network entity (200) in the wireless network (300), wherein the capability information indicates whether the UE (100) is capable for performing random access for early Timing Advance (TA) on at least one Lower-layer Triggered Mobility (LTM) candidate cell; receiving, by the UE (100), a configuration to perform random access towards the at least one LTM candidate cell for receiving the early timing advance (TA); receiving, by the UE (100), a Physical Downlink Control Channel (PDCCH) order from a serving cell to perform the random access towards the at least one LTM candidate cell for receiving the early timing advance; performing, by the UE (100), random access towards the at least one LTM candidate cell for receiving the early timing advance; and logging and reporting, by the UE (100), random access related information about the performed random access.

In an embodiment, the capability information is informed using a single bit of per-UE capability in a UE capability information message.

In an embodiment, the configuration to perform the random access includes contention free random access (CFRA) resources wherein the CFRA resources are separate from the CFRA resources provided for performing a cell switch.

In an embodiment, the random access related information for the early timing advance comprises at least one of: a candidate cell index or a cell identifier of the at least one LTM candidate cell for which random access is performed for the early TA measurement, and a cell identifier of a source cell and an information in which the random access is performed for receiving the early timing advance.

In an embodiment, the information in which the random access is performed for receiving the early timing advance is provided through a raPurpose field in a RA-Report.

In an embodiment, the information in which the random access is performed for receiving the early timing advance is included in a SCG-related RA report.

In an embodiment, the cell identifier is combination of at least one of: a physical cell identifier and a NR-ARFCN (New Radio Absolute Radio Frequency Channel Number), and a global cell identifier.

In an embodiment, the UE (100) reports the random access related information for receiving the early timing advance in at least one of: a random access report, a radio link failure report, a connection establishment failure report, a successful handover report and a successful PSCellAddition or Change report.

In accordance with an embodiment of the disclosure, a method for performing random access for early timing advance in a wireless network (300) is disclosed. The method may comprise: informing, by a gNB centralized unit (CU) (200a), a gNB distributed unit (DU) whether a gNB DU (200b) configures a User Equipment (UE) for performing early TA for a candidate cell; and configuring, by the gNB DU (200b), the configuration for random access for early timing advance in the wireless network (300) in response to informing.

In accordance with an embodiment of the disclosure, a UE (100) for optimizing random access in a wireless network (300) is disclosed. The UE may comprise: a memory (130); a processor (110); and a random access controller (140), communicatively coupled to the memory (130) and the processor (110), configured to: inform capability information to a network entity (200) in the wireless network (300), wherein the capability information indicates whether the UE (100) is capable for performing random access for early Timing Advance (TA) on at least one Lower-layer Triggered Mobility (LTM) candidate cell; receive a configuration to perform random access towards the at least one LTM candidate cell for receiving the early timing advance (TA); receive a Physical Downlink Control Channel (PDCCH) order from a serving cell to perform the random access towards the at least one LTM candidate cell for receiving the early timing advance; perform random access towards the at least one LTM candidate cell for receiving the early timing advance; and log and report random access related information about the performed random access.

In accordance with an embodiment of the disclosure, a wireless network (300) for performing random access for early timing advance is disclosed. The wireless network may comprise: a gNB centralized unit (CU) (200a) informing a gNB distributed unit (DU) (200b) whether a gNB DU (200b) configures a User Equipment (UE) for performing early TA for a candidate cell; and the gNB DU (200b) configuring a configuration for random access for early timing advance in the wireless network (300) in response to informing.

In accordance with an embodiment of the disclosure, a method performed by a terminal is provided. The method may comprise: receiving, from a base station, a radio resource control (RRC) message including configuration information associated with an early timing advance (TA) acquisition; receiving, from the base station, a physical downlink control channel (PDCCH) order related to triggering a random access associated with the early TA acquisition on a lower layer triggered mobility (LTM) candidate cell; and performing the random access associated with the early TA acquisition triggered by the PDCCH order, based on the configuration information.

In an embodiment, the configuration information associated with the early TA acquisition is related to information transmitted from 5G node B-central unit (gNB-CU) to gNB-distributed unit (DU).

In an embodiment, the configuration information is associated with random access resources for the early TA acquisition.

In an embodiment, the performing of the random access associated with the early TA acquisition comprises: transmitting, to the base station, a random access preamble.

In an embodiment, the random access associated with the early TA acquisition is related to a contention free random access (CFRA).

In an embodiment, the random access associated with the early TA acquisition is performed before receiving a cell switch command.

In an embodiment, the method may further comprise transmitting, to the base station, information associated with a capability of the early TA acquisition.

In accordance with an embodiment of the disclosure, a method performed by a base station is provided. The method may comprise: transmitting, to a terminal, a radio resource control (RRC) message including configuration information associated with an early timing advance (TA) acquisition; transmitting, to the terminal, a physical downlink control channel (PDCCH) order related to triggering a random access associated with the early TA acquisition on a lower layer triggered mobility (LTM) candidate cell; and performing the random access associated with the early TA acquisition with the terminal, based on the configuration information.

In an embodiment, the configuration information associated with the early TA acquisition is related to information transmitted from 5G node B-central unit (gNB-CU) to gNB-distributed unit (DU).

In an embodiment, the configuration information is associated with random access resources for the early TA acquisition.

In an embodiment, the performing of the random access associated with the early TA acquisition comprises: receiving, from the terminal, a random access preamble.

In an embodiment, the random access associated with the early TA acquisition is related to a contention free random access (CFRA).

In an embodiment, the random access associated with the early TA acquisition is performed before transmitting a cell switch command.

In accordance with an embodiment of the disclosure, a terminal in a wireless communication system is provided. The terminal may comprise: a transceiver; and at least one processor coupled with the transceiver and configured to: receive, from a base station via the transceiver, a radio resource control (RRC) message including configuration information associated with an early timing advance (TA) acquisition; receive, from the base station via the transceiver, a physical downlink control channel (PDCCH) order related to triggering a random access associated with the early TA acquisition on a lower layer triggered mobility (LTM) candidate cell; and perform, via the transceiver, the random access associated with the early TA acquisition with the base station, based on the configuration information.

In accordance with an embodiment of the disclosure, a base station in a wireless communication system is provided. The base station may comprise: a transceiver; and at least one processor coupled with the transceiver and configured to: transmit, to a terminal via the transceiver, a radio resource control (RRC) message including configuration information associated with an early timing advance (TA) acquisition; transmit, to the terminal via the transceiver, a physical downlink control channel (PDCCH) order related to triggering a random access associated with the early TA acquisition on a lower layer triggered mobility (LTM) candidate cell; and perform, via the transceiver, the random access associated with the early TA acquisition with the terminal, based on the configuration information.

FIG. 8 is a diagram illustrating a UE 800 according to an embodiment of the present disclosure.

Referring to the FIG. 8, the UE 800 may include a processor 810, a transceiver 820, and a memory 830. However, all of the illustrated components are not essential. The UE 800 may be implemented by more or less components than those illustrated in the FIG. 8. In addition, the processor 810, and the transceiver 820, and the memory 830 may be implemented as a single chip according to another embodiment.

The aforementioned components will now be described in detail.

The processor 810 may include one or more processors or other processing devices that control the proposed function, process, and/or method. Operation of the UE 800 may be implemented by the processor 810.

The transceiver 820 may be connected to the processor 810 and transmit and/or receive a signal. In addition, the transceiver 820 may receive the signal through a wireless channel and output the signal to the processor 810. The transceiver 820 may transmit the signal output from the processor 810 through the wireless channel.

The memory 830 may store the control information or the data included in a signal obtained by the UE 800. The memory 830 may be connected to the processor 810 and store at least one instruction, or a protocol, or a parameter for the proposed function, process, and/or method. The memory 830 may include read-only memory (ROM) and/or random access memory (RAM) and/or hard disk and/or CD-ROM and/or DVD and/or other storage devices.

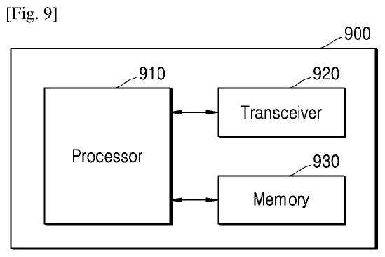

FIG. 9 is a diagram illustrating a base station 900 according to an embodiment of the present disclosure.

Referring to the FIG. 9, the base station 900 may include a processor 910, a transceiver 920 and a memory 930. However, all of the illustrated components are not essential. The base station 900 may be implemented by more or less components than those illustrated in FIG. 9. In addition, the processor 910, and the transceiver 920, and the memory 930 may be implemented as a single chip according to another embodiment. The aforementioned components will now be described in detail.

The processor 910 may include one or more processors or other processing devices that control the proposed function, process, and/or method. Operation of the base station 900 may be implemented by the processor 910.

The transceiver 920 may be connected to the processor 910 and transmit and/or receive a signal. The signal may include control information and data. In addition, the transceiver 920 may receive the signal through a wireless channel and output the signal to the processor 910. The transceiver 920 may transmit a signal output from the processor 910 through the wireless channel.

The memory 930 may store the control information or the data included in a signal obtained by the base station 900. The memory 930 may be connected to the processor 910 and store at least one instruction or a protocol or a parameter for the proposed function, process, and/or method. The memory 930 may include read-only memory (ROM) and/or random access memory (RAM) and/or hard disk and/or CD-ROM and/or DVD and/or other storage devices.

Methods according to the claims of the disclosure or the various embodiments of the disclosure described in the specification may be implemented in hardware, software, or a combination of hardware and software.

When implemented in software, a computer-readable storage medium storing one or more programs (software modules) may be provided. One or more programs stored in the computer-readable storage medium are configured for execution by one or more processors in an electronic device. The one or more programs may include instructions that cause the electronic device to perform the methods in accordance with the claims of the disclosure or the various embodiments of the disclosure described in the specification.

The programs (software modules, software) may be stored in a random access memory (RAM), a non-volatile memory including a flash memory, a read only memory (ROM), an electrically erasable programmable ROM (EEPROM), a magnetic disc storage device, a compact disc-ROM (CD-ROM), a digital versatile disc (DVD) or other types of optical storage device, and/or a magnetic cassette. Alternatively, the programs may be stored in a memory including a combination of some or all of them. There may be a plurality of memories.

The program may also be stored in an attachable storage device that may be accessed over a communication network including the Internet, an intranet, a Local Area Network (LAN), a wide area network (WAN), or a storage area network (SAN), or a combination thereof. The storage device may be connected to an apparatus performing the various embodiments of the disclosure through an external port. In addition, a separate storage device in the communication network may be connected to the apparatus performing the various embodiments of the disclosure.

In the various embodiments of the present disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

While the disclosure has been shown and described with reference to various embodiments thereof, it will be understood by those skilled in the art that various changes in form and details may be made therein without departing from the spirit and scope of the disclosure as defined by the appended claims and their equivalents.

The various actions, acts, blocks, steps, or the like in the flow charts (S400-S600) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a first base station in a wireless communication system, the method comprising:
transmitting, to a second base station, a message for a dual connectivity, the message including configuration information associated with an early timing advance (TA) acquisition for at least one lower layer triggered mobility (LTM) candidate cell in a secondary cell group (SCG);
transmitting, to a terminal, a physical downlink control channel (PDCCH) order related to triggering a random access associated with the early TA acquisition; and
performing the random access associated with the early TA acquisition with the terminal.

17. The method of claim 16, wherein the performing of the random access associated with the early TA acquisition comprises:
receiving, from the terminal, a random access preamble.

18. The method of claim 16, wherein the random access associated with the early TA acquisition is related to a contention free random access (CFRA).

19. The method of claim 16, wherein the random access associated with the early TA acquisition is performed before transmitting a cell switch command.

20. The method of claim 16, further comprising:
receiving, from the terminal, information associated with a capability of the early TA acquisition.

21. The method of claim 16, wherein the first base station corresponds to a secondary node (SN) and the second base station corresponds to a master node (MN).

22. A first base station in a wireless communication system, the first base station comprising:
at least one transceiver;
at least one processor communicatively coupled to the at least one transceiver; and
at least one memory, communicatively coupled to the at least one processor, storing instructions executable by the at least one processor to cause the first base station to:
transmit, to a second base station, a message for a dual connectivity, the message including configuration information associated with an early timing advance (TA) acquisition for at least one lower layer triggered mobility (LTM) candidate cell in a secondary cell group (SCG);
transmit, to a terminal, a physical downlink control channel (PDCCH) order related to triggering a random access associated with the early TA acquisition; and
perform the random access associated with the early TA acquisition with the terminal.

23. The first base station of claim 22, wherein the first base station is further caused to:
receive, from a terminal, a random access preamble.

24. The first base station of claim 22, wherein the random access associated with the early TA acquisition is related to a contention free random access (CFRA).

25. The first base station of claim 22, wherein the random access associated with the early TA acquisition is performed before transmitting a cell switch command.

26. The first base station of claim 22, wherein the first base station is further caused to:
receive, from the terminal, information associated with a capability of the early TA acquisition.

27. The first base station of claim 22, wherein the first base station corresponds to a secondary node (SN) and the second base station corresponds to a master node (MN).

28. A method performed by a terminal in a wireless communication system, the method comprising:
receiving, from a second base station, configuration information associated with an early timing advance (TA) acquisition;
receiving, from a first base station, a physical downlink control channel (PDCCH) order related to triggering a random access associated with the early TA acquisition on at least one lower layer triggered mobility (LTM) candidate cell; and
performing the random access associated with the early TA acquisition, based on the configuration information.

29. The method of claim 28, wherein the terminal is configured with a dual connectivity.

30. The method of claim 28, wherein the first base station corresponds to a secondary node (SN) and the second base station corresponds to a master node (MN).
